(19) United States
(12) Patent Application Publication
(10) Pub. No.: US 2010/0182606 A1
(43) Pub. Date: Jul. 22, 2010

(54) APPARATUS AND METHOD FOR MULTI-PARAMETER OPTICAL MEASUREMENTS

(75) Inventors: Elmar Prenner, Calgary (CA); Kirat Singh, Edmonton (CA)

Correspondence Address: Lambert Intellectual Property Law, Suite 200, 10328 - 81 Avenue, Edmonton, AB, T6E 1X2, CA

(73) Assignee: INNOVISION INC, Edmonton (CA)

(21) Appl. No.: 12/688,110

(22) Filed: Jan. 15, 2010

Related U.S. Application Data
(60) Provisional application No. 61/145,195, filed on Jan. 16, 2009.

(51) Int. Cl. G01N 21/59; G01N 21/49; G01N 21/64; G01N 21/03; G01N 21/41

(52) U.S. Cl. 356/440; 250/576; 250/458.1; 250/429

(57) ABSTRACT

An apparatus and method are provided for optically measuring multiple parameters of a test sample at a regulated temperature. The test sample is held in a cuvette within a sample chamber or a fluidic channel on a fluidic chip. The temperature is sensed and modulated within a desired range. Either excitation light is directed through the test sample, and the emitted light is detected by a detector which converts the detected emission light into an output signal; or a probe light is directed to the test sample and at a detector. The output signal is transmitted to the control system which converts the output signal into output data representative of the fluorescence intensity, optical density and/or refractive index of the test sample.

### FIELD OF THE INVENTION

This invention relates to an apparatus and method for quantifying one or more of fluorescence, optical density and refractive index in a test sample held in a cuvette or fluidic channel.

### BACKGROUND OF THE INVENTION

Optical measurements, in which the transmission of light from a light source across a sample is determined by a detector, are widely used for a range of chemical and clinical investigations. However, the transmission of light can be disturbed in a number of ways, complicating measurements and providing erroneous, inaccurate and unreliable results. Particular parameters of interest, such as fluorescence intensity and refractive index, are functions of temperature. However, current analytical instruments are incapable of achieving multi-parameter analysis, and conducting such analysis at a regulated temperature. Further, current analytical instruments tend to be complex, requiring sophisticated experimental set-ups and specialized training.

Therefore, there is a need for an apparatus and method capable of obtaining multiple optical measurements on samples, and providing correction for the influence of variations in the optical pathway.

### SUMMARY OF THE INVENTION

The present invention is directed to an apparatus and method for quantifying one or more of fluorescence, optical density and refractive index in a test sample held in a cuvette or fluidic channel. In one aspect of the invention, the invention comprises an apparatus for optically measuring one or more of fluorescence intensity, optical density and refractive index in a test sample comprising:

a) a housing having a detection region for receiving a test sample or a cuvette containing the test sample;

b) one or more temperature sensors capable of sensing the temperature of one or more of the housing, the detection region, the test sample or the cuvette;

c) one or more temperature modulators for modulating the temperature of one or more of the housing, the detection region, the test sample or the cuvette within a desired range;

d) either an excitation light source in optical communication with the detection region for directing the excitation light to the test sample, and one or more detectors for detecting emission light from the test sample and for converting the detected emission light into an output signal; or
a probe light source in optical communication with the detection region for directing the probe light to the test sample and at one or more detectors; and

e) a control system in operative communication with the excitation light source or the probe light source, the one or more temperature sensors, the temperature modulators, and the one or more detectors, the control system being capable of converting an output signal from the one or more detectors into output data representative of the fluorescence intensity, optical density and/or refractive index of the test sample.

In another embodiment, there is provided an apparatus for optically measuring one or more of fluorescence intensity, optical density and refractive index in a test sample comprising:

a) a housing having a detection region for receiving a test sample or a cuvette containing the test sample;

b) one or more temperature sensors capable of sensing the temperature of one or more of the housing, the detection region, the test sample or the cuvette;

c) one or more temperature modulators for modulating the temperature of one or more of the housing, the detection region, the test sample or the cuvette within a desired range;

d) a probe light source in optical communication with the detection region for directing the probe light to the test sample;

e) one or more detectors for detecting emission light from the test sample and for converting the detected emission light into an output signal; and

f) a control system in operative communication with the probe light source, the one or more temperature sensors, the temperature modulators, and the one or more detectors, the control system being configured to convert an output signal from the one or more detectors into output data representative of the refractive index of the test sample.

In one embodiment, the housing is selected from a sample chamber which receives the cuvette, or a fluidic chip which incorporates a fluidic channel for receiving the test sample. In one embodiment, the test sample is a liquid, or a liquid containing cells, tissue or other biological materials selected from blood, serum, plasma, saliva, urine, DNA, ocular fluid, spinal fluid, cells, microbes, organelles, or biochemical complexes or above listed samples isolated from water or food samples. In one embodiment, the control system is in electrical communication with an analyzer to transmit the temperature information for analysis. In one embodiment, the temperature modulator comprises one or both of heating and cooling means selected from Peltier elements or heating elements.

In one embodiment, the apparatus further comprises one or more optical filters for spectrally filtering one or both of the excitation light and the emission light, the one or more optical filters being selected from a colored glass filter, a plastic filter, a gelatin filter, a liquid dye filter, a dichroic filter or etalon-type filter, or an optical waveguide based filter. In one embodiment, the apparatus further comprises one or more lenses or optical apertures to converge or diverge one or both of the excitation light and emission light. In one embodiment, the apparatus further comprises a diffraction grating element.

In one embodiment, the excitation light source is selected from a light emitting diode, a resonant cavity light emitting diode, a vertical-cavity surface-emitting laser, a laser, or a spectrally filtered or unfiltered incandescent or fluorescent light source. In one embodiment, the excitation light source is removably attached to a moving arm to produce an oscillating beam of light.

In one embodiment, a probe light source is in optical communication with the detection region for directing the probe light to the test sample and at one or more detectors.

In one embodiment, the detector is selected from a photodiode, an avalanche photodiode, a photomultiplier tube, a single photon counting avalanche photodiode, a charge coupled device, a light dependent resistor or any other photosensitive device capable of detecting light intensity. In one embodiment, the control system is selected from an electronic unit or an on-board control system including a PIC microcontroller or field programmable gate array, an external or integral device including, but not limited to, a computer microprocessor or personal digital assistant.

In one embodiment, the cuvette is square in horizontal cross section and has sides which are non-parallel to its vertical axis. In one embodiment, the cuvette has a modified geometry having one or more of a cross-section of regular polygon, irregular polygon or curved shape; internal or external prisms of arbitrary shape; or sides which are parallel or non-parallel to the vertical axis of the cuvette. In one embodiment, the cuvette has an internal prism and sides which are parallel to its vertical axis to enable light from the excitation light source to be incident on an interface between the sample cuvette and the test sample when in use.

In one embodiment, the fluidic channel is formed by first and second opposing planar substrates, the test sample being held therebetween. In one embodiment, the excitation light source is an optical waveguide, the waveguide comprising one or more layers of dielectric layers, metallic layers or dye-loaded layers deposited on an inner surface of the fluidic channel, wherein one layer of the waveguide contacts the test sample within the fluidic channel. In one embodiment, the apparatus further comprises a prism positioned adjacent to the first planar substrate, and configured to allow light to be coupled into a resonant optical mode confined in the fluidic channel, when the light is incident upon the prism at an angle that satisfies the phase matching condition sin(θ)=β/N where θ is the angle of incidence of the light beam, i.e. the angle between the beam in the substrate and the normal to the plane of the fluidic channel, β is the mode index of the waveguide mode and N is the refractive index of the substrate.

In one embodiment, the apparatus further comprises means for scanning the light from the excitation light source so that it is incident at the optical waveguide over a range of incident angles, the means for scanning light over a range of angles of incidence being selected from a swinging arm or a converging lens or a system of moving mirrors. In one embodiment, the apparatus further comprises means for providing light capable of exciting either transverse electric or transverse magnetic modes. In one embodiment, the apparatus further comprises means for detecting an angle dependent dip or peak in the intensity of the light coupled from the waveguide. In one embodiment, the apparatus further comprises means for detecting single or multiple dips or peaks in intensity of reflected light.

In another aspect of the invention, the invention provides a method for optically measuring one or more of fluorescence intensity, optical density and refractive index in a test sample using the above apparatus, the method comprising:

a) inserting the test sample or the cuvette containing the test sample into the housing;

b) sensing the temperature of one or more of the housing, the detection region, the test sample or the cuvette;

c) modulating the temperature of one or more of the housing, the detection region, the test sample or the cuvette within a desired range;

d) either directing excitation light through the test sample, and detecting the emission light from the test sample, the one or more detectors being capable of converting the detected emission light into an output signal; or
directing the probe light to the test sample and at one or more detectors; and

e) transmitting the output signal to the control system, the control system being capable of converting the output signal into output data representative of the fluorescence intensity, optical density and refractive index of the test sample.

### BRIEF DESCRIPTION OF THE DRAWINGS

The invention will now be described by way of an exemplary embodiment with reference to the accompanying simplified, diagrammatic, not-to-scale drawings:

FIG. 1 is a schematic representation of a top view of an apparatus of the present invention.

FIG. 2 is a schematic representation of a top view of an apparatus of the present invention.

FIG. 3 is a schematic representation of a side view of an apparatus of the present invention.

FIG. 4A is a schematic representation of a side view of an apparatus of the present invention.

FIG. 4B is a schematic representation of a top view of an apparatus of the present invention.

FIG. 5A is a schematic representation of a side view of an apparatus of the present invention.

FIG. 5B is a schematic representation of a side view of an apparatus of the present invention.

FIG. 5C is a schematic representation of a side view of an apparatus of the present invention.

FIG. 6A is a schematic representation of a side view of an apparatus of the present invention.

FIG. 6B is a schematic representation of a side view of an apparatus of the present invention.

FIG. 6C is a schematic representation of a side view of an apparatus of the present invention.

FIG. 7 is a schematic representation of a side view of an apparatus of the present invention.

FIG. 8 is a graph showing the relationship between fluorescence intensity and DNA concentration in a urine sample, with data obtained using an apparatus of the present invention.

### DETAILED DESCRIPTION OF PREFERRED EMBODIMENTS

When describing the present invention, all terms not defined herein have their common art-recognized meanings. To the extent that the following description is of a specific embodiment or a particular use of the invention, it is intended to be illustrative only, and not limiting of the claimed invention. The following description is intended to cover all alternatives, modifications and equivalents that are included in the spirit and scope of the invention, as defined in the appended claims. The invention will now be described having regard to the accompanying Figures.

In one embodiment, the invention relates to an apparatus and method for optically measuring multiple parameters of a test sample simultaneously at a regulated temperature in order that measurement of parameters which are functions of temperature (for example, fluorescence intensity and refractive index) are accurate and reliable. In one embodiment, the parameters are one or more of fluorescence, optical density and refractive index. In one embodiment, the parameters are fluorescence, optical density and refractive index. Further, the invention provides correction for factors which may give rise to erroneous results. Light-scattering and absorption effects in turbid media (“inner filter effects”) have primary and secondary components depending on the conditions. The primary effect is defined as scattering or absorption of the excitation light, while the secondary effect is defined as scattering or absorption of the emitted light (French, S. A., Territo, P. R. and Balaban, R. S. (1998) Am J Physiol. 275(3 Pt 1):C900-9). Fluorescence measurements require that inner filter effects be minimized or compensated for before a quantitative analysis can be made. Aspects of the invention mitigate inner filter effects, hence improve the accuracy of fluorescence studies, through manipulation of the light path geometry.

It will be appreciated that the invention is applicable, without limitation to other applications, to a range of biomedical and life science applications. The test sample is a liquid, or a liquid containing biological, physical or chemical samples including, for example, cells, tissue, blood, serum, plasma, saliva, urine, ocular fluid, spinal fluid, cells, microbes, organelles, biochemical complexes and diagnostic dyes. In one embodiment, the test sample may comprise urine. In one embodiment, DNA in the urine is labelled with fluorescent dye to enable measurement of fluorescence. It will be appreciated that the invention is applicable to other test samples including for example, samples from home, municipal, or industrial water sources, and food samples. Viscous liquid, semi-solid, or solid specimens may be used to create liquid samples; for example, swabs from working surfaces as well as biological surfaces such as, but not limited to, the throat may be suspended in a liquid solution to make a sample, or gases may be dissolved in liquids.

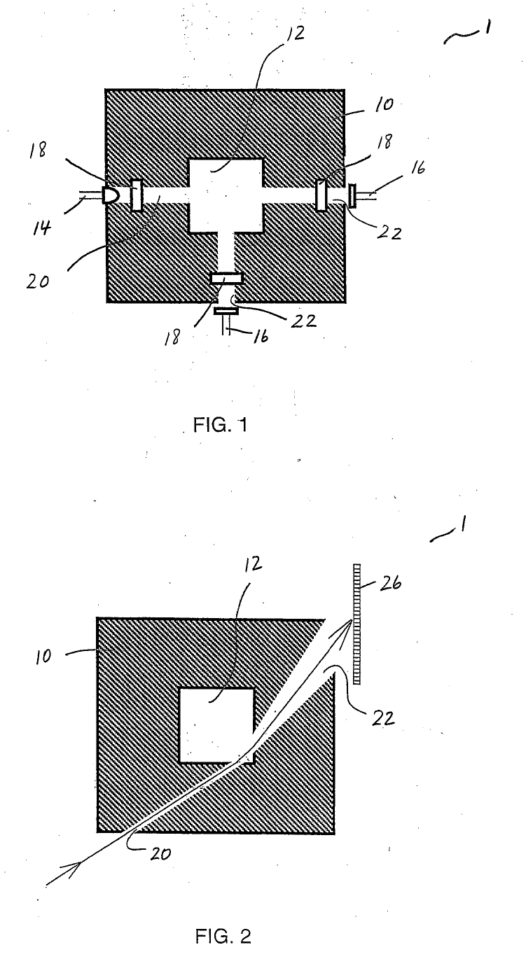

The apparatus of the present invention is shown generally at 1 in FIG. 1 to include a housing in the form of a sample chamber 10 having a detection region 12 for receiving a test sample or a cuvette 24 containing the test sample. The sample chamber 10 is configured to allow the passage of excitation light from an excitation light source 14 through the test sample and the passage of emission light generated from the test sample to one or more detectors 16. One or more optical filters 18 may be included for spectrally filtering one or both of the excitation light and emission light. One or more lenses 38 or optical apertures may be included for converging, diverging, collimating or focusing one or both of the excitation light and emission light.

In one embodiment shown in FIG. 1, the sample chamber 10 defines at least one inlet 20 to allow passage of light from the excitation light source 14 to the sample, and at least one outlet 22 to permit passage of light emitted from the sample to one or more detectors 16. In one embodiment, at least one inlet 20 is positioned aligned with and parallel to the outlet 22. In one embodiment, an inlet 20 is positioned parallel to a first outlet 22 and perpendicular to a second outlet 22. In one embodiment, the sample chamber 10 is formed of an opaque material such as, for example, opaque plastic or metal. In one embodiment, the sample chamber 10 is thermally conductive. In one embodiment, the sample chamber 10 is formed of a transparent or translucent material such as, for example, translucent plastic. In the case that a transparent or translucent material is used, care must be taken to ensure that no light from outside the sample chamber 10 enters where it may be incident on any detector 16.

In one embodiment, the cuvette 24 is sized to fit within the detection region 12. The cuvette 24 may be in the form of any number of different symmetrical (for example, square, rectangular, etc.) or asymmetrical configurations (for example, irregular polygon, wedge-shaped, etc.). In one embodiment, the detection region 12 is of square cross-section. In one embodiment, the cuvette 24 is in the shape of a tube of square cross section. In one embodiment, the cuvette 24 is sealed at one end. In one embodiment, the cuvette 24 is sealed at both ends. The cuvette 24 has sufficient height to hold a liquid test sample and to receive light from the excitation light source 14. It will be understood by those skilled in the art that the cuvette 24 has a height allowing it to be filled with enough test sample to reach the height of the light beam from the excitation light source 14. The cuvette 24 is formed of transparent or light transmitting material such as, for example, clear plastic such as acrylic, glass or optical grade quartz. Standard commercial cuvettes are suitable. The materials are preferably compatible with the test sample and remain intact after exposure to same. The capacity of the cuvette 24 can be varied to meet the expected volumetric size of the test sample. In one embodiment, a standard cuvette having a capacity of approximately 4 ml is suitable. In one embodiment, a standard cuvette having a capacity of greater than approximately 4 ml is suitable. In one embodiment, the cuvette may have a capacity of less than 4 ml to minimize the amount of test sample and reagents required for testing.

The excitation light source 14 is in optical communication through the inlet 20 with the detection region 12 for directing the excitation light to the test sample. In one embodiment, the excitation light source 14 is positioned within or adjacent an inlet 20 to transmit light to the detection region 12 in which the test sample or cuvette is held. In one embodiment, more than one excitation light source 14 may be used to increase the intensity (or vary the nature) of light entering the test sample or cuvette, thereby increasing the intensity of the generated fluorescence. The excitation light source 14 may be for example, a light emitting diode, a resonant cavity light emitting diode, a vertical-cavity surface-emitting laser, a laser, or spectrally filtered or unfiltered incandescent or fluorescent light source.

The detector 16 detects the emission light from the test sample and converts the detected emission light into an electrical output signal. Suitable detectors 16 include, for example, a photodiode, an avalanche photodiode, a photomultiplier tube, a single photon counting avalanche photodiode, a charge coupled device, a light dependent resistor or any other photosensitive device capable of detecting light intensity. In one embodiment, the detector 16 is a photodiode.

The filters 18 spectrally filter the light. In one embodiment, a filter 18 can be positioned between the excitation light source 14 and the detection region 12 to act as an “excitation filter”, selecting desired wavelengths of the excitation light and transmitting the filtered excitation light to the test sample. In one embodiment, a filter 18 can be positioned between the detection region 12 and the detector 16 to act as an “emission filter”, preferentially rejecting the excitation wavelength and substantially transmitting the fluorescence wavelengths. The “excitation filter” is required to filter the wavelengths emanating from the excitation light source 14 which would otherwise be transmitted by the emission filter in front of the detector 16. If such filters were absent, a portion of light from the excitation light source 14 may be incident on the detector 16. This portion of light would be indistinguishable from fluorescence and would lead to inaccurate results.

Suitable filters include, for example, absorption filters (for example, a colored glass, plastic, gelatin or liquid dye); interference filters (for example, dichroic or etalon-type); or a filter based on optical waveguide coupling. The dichroic or “all dielectric” filters work by interference between the reflections from the interfaces of multiple layers of differing indexes. The thin film Fabry-Perot etalon-based filters (commonly known as interference filters) have a layer which acts as an etalon with a partially reflective coating on each side. When either an interference or a dichroic filter is selected, the light is preferably substantially collimated before being incident on the interference or dichroic filter. As used herein, the term “collimated” light refers to light whose rays are largely parallel (i.e., have little or no angular spread). Light can be collimated by using any combination of lenses or optical apertures and adjusting the distance between the sample or cuvette and filter 18.

In one embodiment, the apparatus includes means for temperature regulation including (i) one or more temperature sensors; (ii) temperature modulators; and (iii) a control system in electrical communication with the one or more temperature sensors and the temperature modulators. It is desirable that the temperature remains constant during and between measurements. Further, it will be appreciated by those skilled in the art that a temperature is chosen which avoids problems such as condensation and evaporation, and is compatible with the chemistry of the compounds (for example, fluorophores) within the sample and the thermal properties of the cuvette 24.

In one embodiment of the cuvette-based apparatus, one or more temperature sensors are included to sense the temperatures of one or more of the cuvette 24, the test sample within the cuvette 24, the detection region 12 and the sample chamber 10 at one or more points. In one embodiment, temperature sensors can be positioned for example, on the base of the sample chamber 10. In one embodiment of the fluidic chip-based apparatus, one or more temperature sensors are included to sense the temperatures of the fluidic chip and the test sample.

In one embodiment, the apparatus includes temperature modulators for modulating the temperature of one or more of the sample chamber 10, the detection region 12, the test sample or the cuvette 24 within a desired range as defined by the user. In one embodiment, the temperature ideally is the same for each measurement. In one embodiment, the temperature is slightly above room temperature. In one embodiment, the temperature modulator comprises either or both of heating and cooling elements. In one embodiment, the control system monitors the temperature and adjusts the heating or cooling by suitably changing the current flowing through Peltier elements or heating elements. The control system delivers the temperature information to analysis software, which normalizes the measurements of fluorescence intensity, optical density and refractive index according to the obtained temperatures. For most fluorescent species, the fluorescence intensity is known to be a function of temperature. For most fluids, the refractive index varies with changes in temperature. The relationship between fluorescence intensity and temperature and between refractive index and temperature can be determined experimentally, and used for normalizing these parameters with temperature.

The control system is also in electrical communication with the excitation light source 14 and the one or more detectors 16. The control system converts the electrical output signal from the one or more detectors 16 into output data representative of the selected parameters of the test sample. Data can be stored, displayed or read. The control system is selected from an electronic unit including for example, a PIC microcontroller or field programmable gate array, or any other suitable electronic component. In one embodiment, the apparatus may be controlled directly by an external or integral device including, but not limited to, a computer microprocessor or personal digital assistant (PDA). In one embodiment, the apparatus includes an on-board control system including, for example, a PIC microcontroller or field programmable gate array, or any other suitable electronic component, and has the capability of interfacing with a device including, but not limited to, a computer or PDA, for any combination of control, data processing, display or data storage purposes. The control system is powered either by a mobile power source (for example, cells or batteries), or derives power from an external power source (for example, a mains adaptor or any external device such as, for example, a PDA or PC).

In operation of the embodiment shown in FIG. 1, the apparatus 1 can be used to quantify fluorescence by mounting the sample or cuvette 24 containing the test sample within the detection region 12. The excitation light source 14 provides light which passes through the filter 18 (if used) and enters the cuvette 24, causing any fluorescent species present in the test sample, whose absorption spectrum overlaps with the spectrum of the excitation light, to fluoresce. A portion of the fluorescent light emitted from the test sample passes through the filter or filters 18 to the detectors 16. The detectors 16 convert these optical signals representative of the emitted fluorescent light into electrical signals, and transmits them to the control system (not shown). The control system may amplify or manipulate the electrical signals, and stores, displays or enables reading of the resultant data. The fluorescence intensity is generally proportional to the concentration of fluorescent species within the test sample, as demonstrated in Example 3.

Detection and measurement of fluorescence may also be conducted by a confocal method. Excitation light is focused onto the test sample held within the cuvette 24 or fluidic channel 44 via a dichroic filter, which at a specific angle of incidence, largely transmits light at the excitation wavelength and largely reflects light at the fluorescence wavelengths. Excitation light is substantially collimated and passes through the dichroic filter set at a specific angle. Excitation light is largely transmitted, while fluorescence light is largely reflected.

The light path geometry (i.e., angle and position of light entering the test sample can be chosen to generate data for quantifying refractive index in a test sample. In one embodiment shown in FIG. 2, the sample chamber 10 defines an inlet 20 and outlet 22 positioned in its walls such that the light enters the detection region 12 and into the cuvette 24 on one side and exits on an adjacent side. The light is detected by a suitable detector 16 such as, for example, a linear photosensor array 26 placed in a known fixed position at a known distance from the cuvette 24. The position at which the light is incident upon the linear photosensor array 26 is used to calculate the refractive index of the test sample within the cuvette 24. The refractive index is calculated using Snell's law, which describes the relationship between the angle of incidence and refraction when referring to light passing through a boundary between two different media. The ratio of the sines of the angles of incidence (θ) and refraction is equal to the ratio of velocities (v) in the two media, or equivalently to the inverse ratio of the indices of refraction (n):

$$\begin{matrix}\frac{sin {θ}_{1}}{sin {θ}_{2}} = \frac{{v}_{1}}{{v}_{2}} = \frac{{n}_{2}}{{n}_{1}} \\ or & ( 1 ) \\ {n}_{1} sin {θ}_{1} = {n}_{2} sin {θ}_{2} . & ( 2 )\end{matrix}$$

Measurement of refractive index of the test sample is also achieved by use of either:

i) a cuvette, which is square in cross section and whose sides are not parallel to the vertical axis of the cuvette, or

ii) a cuvette of modified geometry, for example:
a) a cross-section of regular polygon, irregular polygon or curved shape;
b) internal or external prisms of arbitrary shape; or
c) sides which are parallel or non-parallel to the vertical axis of the cuvette.

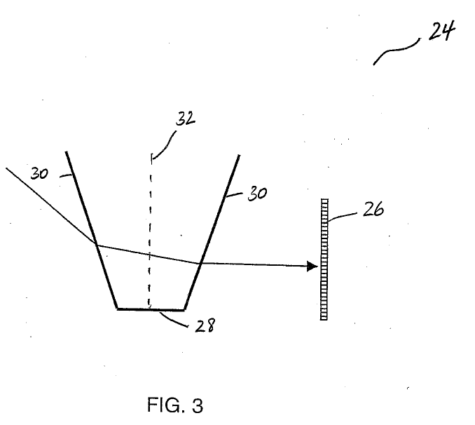

In one embodiment shown in FIG. 3, a cuvette 24 is square in cross section and has sides which are not parallel to the vertical axis of the cuvette. The cuvette 24 has a base 28 from which one or both sides 30 extend upwardly at an angle in relation to the vertical axis 32 of the cuvette 24. Light from the excitation light source 14 enters the cuvette 24 on one side and exits on the opposite side. The cuvette 24 is wedge-shaped and acts as a prism to the incoming light. The light is detected by a suitable detector 16 such as, for example, a linear photosensor array 26 placed in a known fixed position at a known distance from the cuvette 24. The position at which the light is incident upon the linear photosensor array 26 is used to calculate the refractive index of the fluid within the cuvette 24 as described above.

In one embodiment, the excitation light source 14 can be positioned such that light enters the cuvette 24 from one side beneath the cuvette 24, with the detector 16 (for example, a fluorescence photodiode) being suitably positioned in proximity to and parallel to a vertical side of the cuvette 24.

In one embodiment, the excitation light source 14 may be positioned such that light enters the cuvette 24 from one vertical side of the cuvette 24, with the detector 16 (for example, a fluorescence photodiode) being suitably positioned in proximity to and parallel to the bottom side of the cuvette 24. The position at which the light is incident upon the detector 16 is used to calculate the refractive index of the fluid within the cuvette 24 as described above.

The measurement of refractive index may also be facilitated by use of a diffraction grating element. As used herein, the term “diffraction grating element” refers to an array of fine, parallel, spaced reflecting or transmitting lines that mutually enhance the effects of diffraction to concentrate the diffracted light from a probe beam in a few directions determined by the spacing of the lines and by the wavelength of the light, and the refractive index of the liquid. A diffraction grating element is positioned in such a way that the diffraction pattern is affected by the refractive index of the test sample which is in contact with the surface of the diffraction grating element. A linear or 2D CCD array is used to analyze the diffraction pattern to determine the refractive index of the test sample.

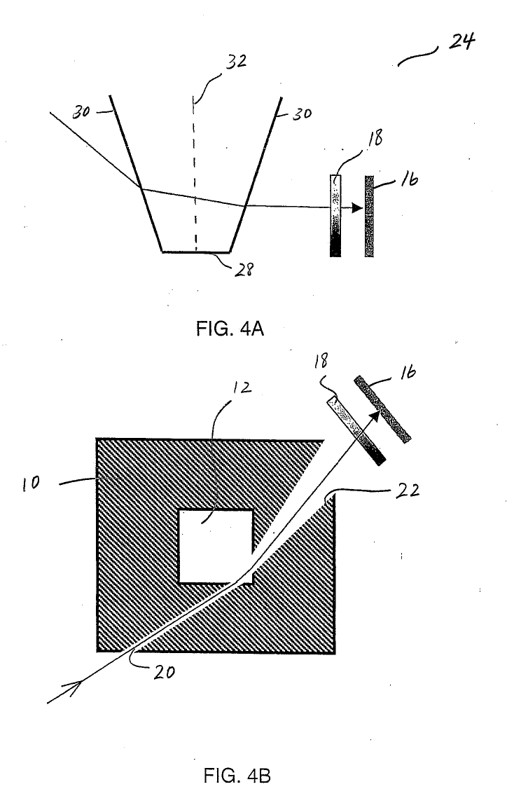

As shown in FIGS. 4A and 4B, a filter 18 may be positioned in front of the detector 16 such that the light exiting from the cuvette 24 passes through the filter 18 before reaching the detector 16. In one embodiment, the detector 16 is a single photodiode, and the filter 18 is a graded filter, meaning that the transmission of light is a function of position of incidence on the graded filter, and thereby also of position of incidence on the detector 16. By measuring the intensity of transmitted light, it is possible to determine the position at which the light beam was incident on the graded filter. Knowing the position of the beam at incidence on the graded filter, the angle of the beam can be calculated and the refractive index determined by Snell's law. This assumes that the intensity of the light (for example, light from a probe beam) is constant, since variations in intensity of the source would lead to variations in the signal that would be indistinguishable from variations due to change in refractive index.

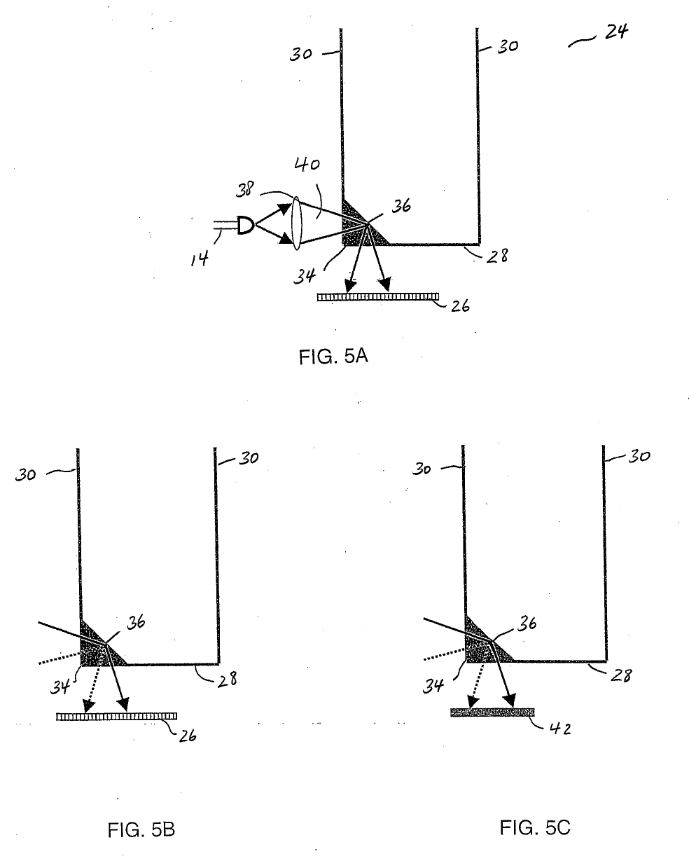

FIGS. 5A, 5B and 5C show a cuvette 24 of modified geometry, having an internal prism 34 and sides 30 which are parallel to the vertical axis 32 of the cuvette 24. Light from the excitation light source 14 is caused to be incident on an interface 36 between the cuvette 24 and the test sample. The direction of incidence thus originates from within the internal prism 34. In one embodiment, the light passes through a lens 38 to be incident on the interface 36 in the form of a converging or diverging wedge beam 40. In one embodiment, the light passes through two lenses 38, such that the light is collimated between the two lenses before being incident on the interface 36 in the form of a converging or diverging wedge beam 40.

The vertex angle of the wedge beam 40 is such that a sufficiently large incidence angle range is covered to allow determination of the refractive index of the test sample over the experimentally anticipated refractive index range. As an example, a polystyrene cuvette and integral prism have a refractive index of 1.6 which is typical of polystyrene. If the anticipated refractive index range is 1.3 to 1.4, the angle range of approximately 57 to 62 degrees would need to covered. A larger range of approximately 55 to 65 degrees would need to be covered to account for batch-to-batch variability in cuvette flatness (i.e., the flatness of the cuvette walls and surface of the prism) and variations in parallelism and material refractive index. The refractive index of the test sample is determined by using a photosensor array 26 to determine the angle of incidence beyond which total internal reflection occurs (the critical angle), and applying Fresnel equations relating the critical angle to the refractive indices of the superstrate (i.e., the test sample) and substrate (i.e., the cuvette). It is assumed that the refractive index of the substrate (i.e., the cuvette) is known.

In one embodiment, an oscillating beam of light is incident on the interface 36, with the range of angles covered by the oscillating beam being sufficiently large to allow determination of the refractive index of the test sample over the experimentally anticipated refractive index range. The oscillating beam may be generated by mounting the light-emitting source 14 on a moving arm (not shown), with the pivot point in line with the interface 36. The refractive index of the test sample is determined by using a photosensor array 26, for example, CCD shown in FIG. 5B or a photodiode 42, shown in FIG. 5C as described above. With respect to the configuration shown in FIG. 5B, the angular position of the onset of total internal reflection can be determined by the pixel at which maximum intensity is reached. With respect to the configuration shown in FIG. 5C, the apparatus must track the angle of incidence of the excitation light source (for example, a probe beam) at all times. The point at which the signal from the photodiode 42 reaches a maximum determines the onset of total internal reflection. The value of the critical angle is related to the refractive indices of the cuvette 24 and the sample within the cuvette 24.

Measurement of the optical density of the test sample is also achieved using the apparatus 1 of the present invention. As used herein, the term “optical density” refers to the absorbance of an optical element for a given wavelength λ per unit distance. As light from the excitation light source 14 enters the test sample, a portion of the light may be absorbed. A portion of this light is caused to be incident upon the detector 16, having traversed a known distance through the test sample. The amount of light incident on the detector 16 can be used to calculate the optical density of the test sample using the formula:

$${OD}_{λ} = \frac{{A}_{λ}}{l} = - \frac{1}{l} {log}_{10} T = \frac{1}{l} {log}_{10} ( \frac{{I}_{0}}{I} ) \qquad ( 3 )$$

where:
l=the distance that light travels through the sample (i.e., the sample thickness), measured in cm
A_{λ}=the absorbance at wavelength λ
T=the per-unit transmittance
I₀=the intensity of the incident light beam
I=the intensity of the transmitted light beam

The excitation light source 14 may be used to excite fluorescence and also provide light for measurement of optical density. The excitation light source 14 can be positioned to direct light to the test sample in any of the configurations previously described. The excitation light source 14 may be used without filters 18 if the spectral width of the excitation light source 14 is sufficiently narrow and non-dominant spectral emission is sufficiently low (i.e., the spectrum of the excitation source does not significantly overlap with the transmission spectrum of the emission filter. However, the excitation light source 14 can be spectrally filtered such that the range of wavelengths transmitted by the filter 18 is similar or identical to that used to excite fluorescence in the test sample. The filter 18 in front of the detector used for optical density measurements preferentially rejects fluorescence wavelengths and transmits the wavelengths of the spectrally filtered light required for measuring optical density. The filter 18 is selected from a colored glass or dye-based filter, or an interference filter or dichroic filter. Preferably, the light is substantially collimated before being incident on the interference filter or dichroic filter using any combination of lenses and optical apertures, and adjusting the distance between the sample cuvette and filter.

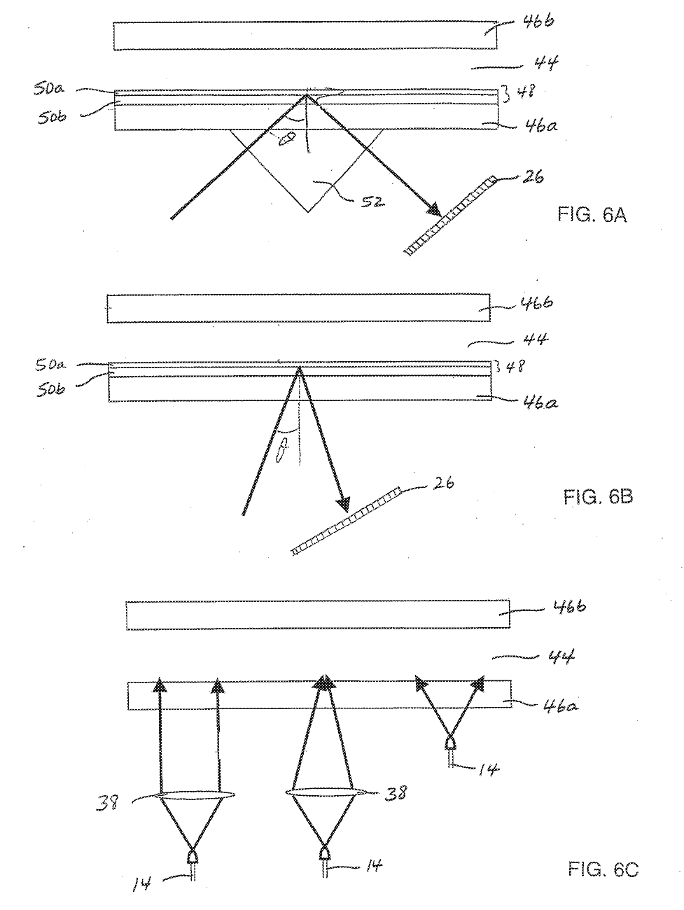

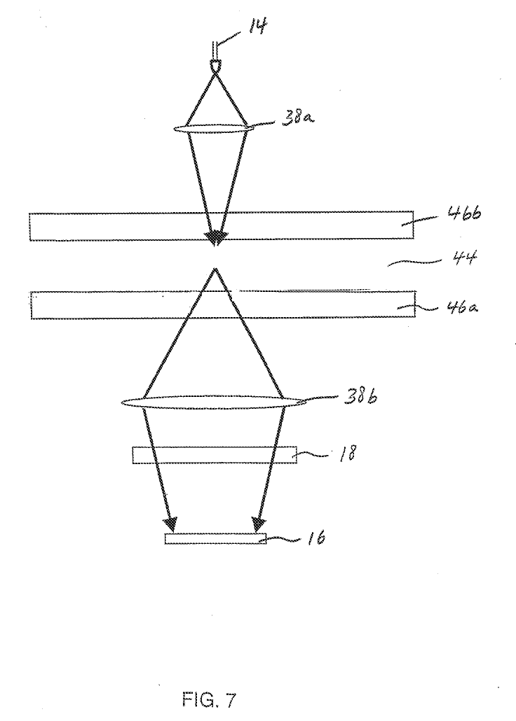

Those skilled in the art will appreciate that various modifications can be made without altering the substance of the invention. Microfluidic systems integrate sample preparation and biological assays on a single substrate, reducing manual operations and reagent use and thereby minimizing costs in performing tests. In one embodiment, the housing comprises a fluidic chip which incorporates a fluidic channel 44 in which the test sample is held. As shown in FIGS. 6A, 6B, 6C and 7, the fluidic channel 44 is formed by first and second opposing substrate layers, designated as substrate 46a and superstrate 46b. In one embodiment, the layers are formed of entirely or substantially transparent materials such as, for example, glass or polymer. In one embodiment, the layers are formed of the same material. In one embodiment, the layers are formed of different materials. In one embodiment, the layers are colored so as to spectrally filter the excitation light at the substrate 46a, or to block excitation light from exiting the superstrate 46b. Preferably, in one embodiment, no material should be fluorescent at the excitation wavelength. However, if there is fluorescence, any such fluorescence signal should be spectrally distinct from the fluorescence signal of the fluorophore used in the apparatus, such that with appropriate filtering, the fluorescence from the structure can be removed or strongly attenuated with respect to the fluorescence from the fluorophore used in the experiment and contained within the fluidic channel 44.

In one embodiment, the substrate 46a has a refractive index greater than the refractive index of the test sample within the fluidic channel 44. In one embodiment, the substrate 46a has a refractive index greater than the mode index of the waveguide mode which is excited. In one embodiment, the mode is optically leaky, and prism coupling is used. It will be understood by those skilled in the art that when light crosses a boundary between materials with different refractive indices, the light is partially refracted at the boundary surface and partially reflected. However, if the angle of incidence is greater (i.e. the light is closer to being parallel to the boundary) than the critical angle (i.e., the angle of incidence at which light is refracted such that it travels along the boundary), then the light does not cross the boundary and instead reflects back internally. This occurs where light travels from a medium with a higher refractive index to one with a lower refractive index.

In one embodiment, the superstrate 46b may be formed of translucent material, since all that is required optically of the superstrate 46b is that a portion of the fluorescence light be able to pass through for detection. In one embodiment, the superstrate 46b may have a refractive index greater than the refractive index of the sample within the fluidic channel 44.

In one embodiment, the excitation light source 14 for transmitting excitation light to the test sample within the fluidic channel 44 is an optical waveguide 48, as shown in FIGS. 6A and 6B.

In one embodiment, the test sample within the fluidic channel 44 is optically excited by the evanescent tail of the optical mode in an optical waveguide as shown in FIGS. 6A and 6B.

The optical waveguide 48 comprises one or more layers 50a, 50b of dielectric layers, metallic layers or dye-loaded layers deposited on an inner surface of the fluidic channel 44, wherein one layer 50a of the waveguide 48 is in contact with the test sample within the fluidic channel 44. Suitable metallic layer(s) comprise for example, chromium, aluminum, gold, silver and other appropriate metals. The choice of metallic layer(s) depends upon many factors that are well known to those skilled in the art including, for example, the compatibility of the metal with surrounding materials (for example, can the metal be deposited onto glass or polystyrene); the complex refractive index of the metal at the wavelength of mode excitation; the cost of the metal; the deposition of the metal; and the chemical inertness of the metal (for example, silver would tend to oxidize and tarnish over time if it is used as the surface layer). In one embodiment, the upper dielectric layer 50a is selected from silicon nitride, hafnium oxide or tantalum pentoxide. In one embodiment, the lower dielectric layer 50b is silicon dioxide.

In one embodiment, the waveguide 48 supports one or more optical modes whose evanescent tail(s) extends into the fluidic channel 44. In one embodiment, the waveguide 48 supports a first order mode which peaks in the fluidic channel 44.

In one embodiment, the fluidic channel itself 44 may serve as the core of the waveguide, exploiting high Fresnel reflectivity at the core-cladding interface to largely confine light within the fluidic core. In this arrangement, the layers of metallic and/or dielectric materials 50a, 50b may be used to optimize waveguide performance (for example, to minimize optical leakage or may be omitted entirely).

As shown in FIG. 6A, the method of prism or grating coupling via the substrate 46a is used to excite the waveguide mode. The means for coupling light from the excitation light source 14 into an optical mode confined in the fluidic channel 44 comprises a prism 52. In one embodiment, the prism 52 is positioned adjacent to the substrate 46a to ensure optical contact. In one embodiment, the prism 52 is formed of transparent or light transmitting material such as, for example, glass. The prism 52 allows light to be coupled into a resonant optical mode confined in the fluidic channel 44, when the light is incident upon the waveguide at a resonant angle (θ=θ_{R}) which satisfies the phase matching condition. A change of the refractive index of the test sample within the fluidic channel 44 changes the resonant angle (θ_{R}) which excites a specific resonant mode of the optical waveguide 44. The resonant angle (θ_{R}) depends upon the mode index of the waveguide, which in turn depends on the waveguide design and wavelength. In general, the resonant angle (θ_{R}) is related to the mode index (β) by the phase matching condition (sin(θ_{R})=β/N where N is the refractive index of the prism).

The optical waveguide is capable of supporting an optical mode or modes largely confined in the fluidic channel 44. The optical waveguide may be used to concentrate an optical field in the low refractive region, i.e. the fluid within the fluidic channel 44. The reference above to a mode being largely confined in the fluidic channel 44 is intended to mean that the mode is centered on that layer 44 of the optical waveguide. It will be appreciated that a proportion of the mode may extend beyond that layer.

In one embodiment, a low index spacer layer and high index waveguide layer may be included between the substrate 46a and fluidic channel 44, with the low index spacer layer being adjacent to the substrate 46a. These additional low and high index layers allow resonant mirror modes as well as the fluid core modes to be excited in a single waveguide, thereby allowing comparison between them. The resonant mirror mode or modes are generally wavelength sensitive, meaning that the angle of optical excitation required to efficiently excite the resonant mirror mode (i.e. the resonant angle) depends on the excitation wavelength. For this reason, it is suggested to use a spectrally narrow excitation source for resonant mirror modes and the wavelength sensitive high order fluid core modes. Generally, spectrally broad excitation sources can be used for the wavelength insensitive low-order fluid-core modes.

Scattering or absorbing elements may be included to cause scattering or absorption in one or more of the layers of the optical structure, or by providing one or more of those layers with roughened surfaces. Scattering or absorbing elements may comprise metal layers, metallic or dye-based colloidal particles or dye-based layers. In one embodiment, the scattering layers may be particles whose refractive index differs from the surrounding material. Roughened surfaces also scatter provided that the roughing produces local variations in the refractive index. The purpose of introducing scattering and/or absorbing elements and/or roughened surfaces is to produce a dip in reflectivity at the resonant angle to facilitate location of the resonant angle.

In one embodiment, the present invention provides an apparatus comprising an optical waveguide, an excitation light source 14, coupling means for coupling light from the excitation light source 14 into an optical mode confined within the fluidic channel 44, and one or more detectors 26 for monitoring properties of light coupled from the waveguide structure to detect changes in the properties of the optical mode.

In one embodiment, the apparatus may include means for scanning the light from the excitation light source 14 so that it is incident at the optical waveguide over a range of incident angles. The range of incident angles which would cover the resonant angle depends upon the waveguide structure, materials used, the wavelength of light, and refractive index of the sample, as illustrated in Example 1. This may be achieved for example, by mounting the excitation light source 14 on a swinging arm. Alternatively, means may be provided to direct light from the excitation light source 14 onto the optical waveguide from many angles simultaneously for example, by using a converging lens to form a wedge beam of light.

In one embodiment, the apparatus may include means for providing light capable of exciting either transverse electric (TE) or transverse magnetic (TM) modes confined in the fluidic channel 44. For the former, the electric field is confined to the transverse plane, while the magnetic field is so confined for the latter. The excitation light source 14 may have a spectrally narrow spectrum, or be capable of producing a broad spectrum of wavelengths of light.

In one embodiment, the apparatus may include means for detecting an angle dependent dip or peak in the intensity of the light coupled from the waveguide. Should the waveguide structure cause scattering, or absorption of light confined within the fluidic channel 44, a dip in the intensity of light coupled from the optical waveguide indicates the presence of a waveguide mode.

In one embodiment, the apparatus includes means for detecting single or multiple dips or peaks in intensity of reflected light. A linear (i.e. one-dimensional) or two-dimensional CCD array is positioned so that light reflected from the waveguide structure is incident on the CCD array. By determining the position of one or more of the dips or peaks in intensity of reflected light (each dip corresponding to a known mode of the waveguide—either resonant mirror mode or fluidic core mode), the refractive index of the test sample can be calculated.

The apparatus is calibrated whereby the angular position of the dip in intensity of reflected light corresponding to any given mode is known through a pre-determined standard curve relating angular position to refractive index of the fluidic sample. The refractive index of the sample is determined by mapping the observed angular position of the dip in intensity of any given waveguide mode to the refractive index of the sample, via the corresponding standard curve.

The size of the dip in intensity (i.e. reflectivity as measured at the center of the dip) and/or angular width of the dip depend on the optical absorption and/or optical scattering within the optical waveguide. One component of optical absorption is absorption of light by the test sample. Optical absorption of light by a fluid is defined in terms of the optical density (OD) of the fluid. In one embodiment, the apparatus is calibrated whereby the size of the dip in intensity of reflected light corresponding to any given mode is known through a pre-determined standard curve relating size of the dip in intensity to the optical density of the test sample. The optical density of the test sample is determined by mapping the observed size of the dip in intensity of any given waveguide mode to the optical density of the sample, via the corresponding standard curve.

In one embodiment shown in FIG. 6B, a high-order optical mode may be excited, wherein the angle of incidence (θ) is sufficiently large that optical excitation can be effected without the use of either a prism 52 or grating. In this case, light from the excitation light source 14 can be coupled into the fluidic waveguide core by direct illumination of the waveguide structure, at an angle of incidence that allows phase matching into a particular mode. The angle of incidence (θ) depends upon the refractive indices of the substrate 46a and sample, thickness of the fluidic channel 44 and the wavelength of light, as illustrated in Example 2.

In one embodiment shown in FIG. 6C, shining light directly onto the fluidic channel 44 via the substrate 46a or superstrate 46b effects optical excitation. In one embodiment, the light beam is collimated (depicted by parallel arrows). In one embodiment, the light beam is focused (depicted by converging arrows). In one embodiment, the light beam is de-focused (depicted by diverging arrows). In one embodiment, the excitation light from the excitation light source 14 is spectrally filtered. In one embodiment, the excitation light from the excitation light source 14 is spectrally unfiltered.

As shown in FIG. 7, the fluorescence emission is detected by placing the detector 16 on the opposite side of the fluidic channel 44. In one embodiment, a coloured glass or dye-based filter 18 is placed in front of the detector 16 to reject excitation light and transmit the fluorescence light. In one embodiment, an interference filter or dichroic filter is used, with the light being substantially collimated before being incident on the interference filter or dichroic filter using any combination of lenses and optical apertures and adjusting the distance between the fluidic channel 44 and filter 18.

In one embodiment, a lens 38a is used to focus the excitation light within the test sample. A proportion of the fluorescence light, excited within the same region in the fluidic channel 44, is collected and collimated by the same lens 38a used to focus the excitation light. The largely collimated fluorescence light is incident on the dichroic filter 18, which reflects a large proportion of the fluorescence light directly onto the detector 16. A second lens 38b focuses the fluorescence light onto the detector 16.

In one embodiment, a dichroic filter, interference filter or dye filter is used to reject scattered excitation light reaching the fluorescence detector 16. If an interference or dichroic filter is used, the filter 18 is placed between the dichroic filter and the detector in a region where the excitation light is largely collimated. A dye based filter may be placed at any point between the dichroic filter and the detector.

The present invention is described in the following Examples, which are set forth to aid in the understanding of the invention, and should not be construed to limit in any way the scope of the invention as defined in the claims which follow thereafter.

### Example 1

In the fluidic chip-based apparatus, means for scanning the light from the excitation light source so that it is incident at the optical waveguide over a range of incident angles may be used. This example is included to demonstrate that the range of incident angles which would cover the resonant angle depends upon the waveguide structure, materials used, the wavelength of light, and refractive index of the sample:

| | |
|---|---|
| Sample | refractive index in the range 1.33 to 1.40 |
| Prism | refractive index of 1.6 |
| Substrate | refractive index of 1.6 |
| Spacer layer | refractive index of 1.47; |
| (adjacent to substrate) | thickness of 0.55 microns |
| Waveguiding layer | refractive index of 2.0; |
| (adjacent to the spacer layer) | thickness of 0.08 microns |
| Wavelength of light | 0.66 microns |

Given the above fluidic-based apparatus, for the fundamental transverse electric (TE) mode, the range of angles is approximately 75-80 degrees, and for the fundamental transverse magnetic (TM) mode, the range of angles is approximately 65-70 degrees.

### Example 2

In the fluidic chip-based apparatus, a high-order optical mode may be excited, wherein the angle of incidence (θ) is sufficiently large that optical excitation can be effected without the use of either a prism or grating (as shown in FIG. 6B). Light from the excitation light source can be coupled into the fluidic waveguide core by direct illumination of the waveguide structure, at an angle of incidence that allows phase matching into a particular mode. This example is included to demonstrate that the angle of incidence (θ) depends upon the refractive indices of the substrate and sample; thickness of the fluidic channel; and the wavelength of light:

| | |
|---|---|
| Sample | refractive index of 1.35 |
| Substrate | refractive index of 1.5 |
| Fluidic channel | thickness of 25 microns |
| Wavelength of light | 0.66 microns |

Given the above fluidic chip-based apparatus, the angle of incidence (θ) has a range of 0 to about 65 degrees. A slightly diverging or converging light beam, converging in a range of angles of about 0.5-10 degrees and central on any angle in the range of 0 to about 65 degrees (for example, 60 degrees) would be used.

### Example 3

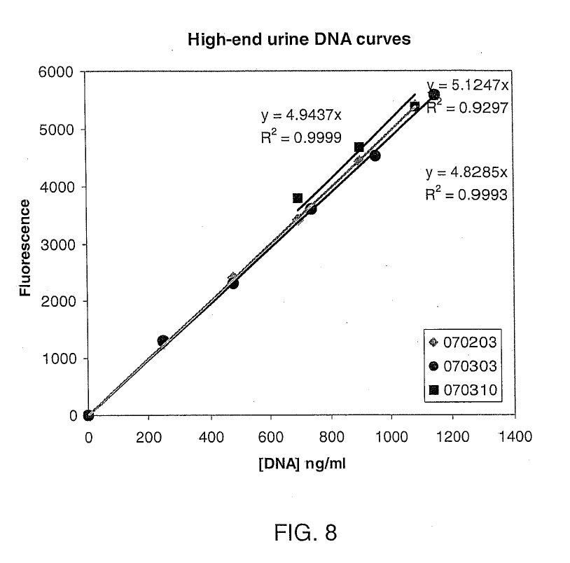

FIG. 8 is a graph showing the relationship between fluorescence intensity and DNA concentration in a urine sample, with data obtained using a cuvette-based apparatus of the present invention. The fluorescence intensity is generally proportional to the DNA concentration within the urine sample.

As will be apparent to those skilled in the art, various modifications, adaptations and variations of the foregoing specific disclosure can be made without departing from the scope of the invention claimed herein.

What is claimed is:

1. An apparatus for optically measuring one or more of fluorescence intensity, optical density and refractive index in a test sample comprising:
a) a housing having a detection region for receiving a test sample or a cuvette containing the test sample;
b) one or more temperature sensors capable of sensing the temperature of one or more of the housing, the detection region, the test sample or the cuvette;
c) one or more temperature modulators for modulating the temperature of one or more of the housing, the detection region, the test sample or the cuvette within a desired range;
d) a probe light source in optical communication with the detection region for directing the probe light to the test sample;
e) one or more detectors for detecting emission light from the test sample and for converting the detected emission light into an output signal; and
f) a control system in operative communication with the probe light source, the one or more temperature sensors, the temperature modulators, and the one or more detectors, the control system being configured to convert an output signal from the one or more detectors into output data representative of the refractive index of the test sample.

2. The apparatus of claim 1 further comprising an excitation light source in optical communication with the detection region for directing excitation light to the test sample, the control system being in operative communication with the excitation light source and the control system being further configured to convert an output signal from the one or more detectors into output data representative of one or both of the fluorescence intensity and optical density of the test sample.

3. The apparatus of claim 2, wherein the control system is in electrical communication with an analyzer to transmit the temperature information for analysis.

4. The apparatus of claim 3, wherein the temperature modulator comprises one or both of heating and cooling means selected from Peltier elements or heating elements.

5. The apparatus of claim 2, further comprising one or more lenses or optical apertures to converge, diverge, collimate or focus one or both of the excitation light and emission light.

6. The apparatus of claim 5 further comprising a diffraction grating element.

7. The apparatus of claim 2, wherein the excitation light source is selected from a light emitting diode, a resonant cavity light emitting diode, a vertical-cavity surface-emitting laser, a laser, or a spectrally filtered or unfiltered incandescent or fluorescent light source.

8. The apparatus of claim 7, wherein the excitation light source is removably attached to a moving arm to produce an oscillating beam of light.

9. The apparatus of claim 1 wherein the housing comprises a sample chamber which receives a cuvette.

10. The apparatus of claim 9, wherein the cuvette is square in horizontal cross section and has sides which are non-parallel to its vertical axis.

11. The apparatus of claim 9, wherein the cuvette has an internal prism and sides which are parallel to its vertical axis to enable light from the excitation light source to be incident on an interface between the sample cuvette and the test sample when in use.

12. The apparatus of claim 1, wherein the housing comprises a fluidic chip which incorporates a fluidic channel for receiving the test sample.

13. The apparatus of claim 12, wherein the fluidic channel is formed by first and second opposing planar substrates, the test sample being held therebetween.

14. The apparatus of claim 2, wherein the excitation light source comprises an optical waveguide, the waveguide comprising one or more layers of dielectric layers, metallic layers or dye-loaded layers deposited on an inner surface of the fluidic channel, wherein one layer of the waveguide contacts the test sample within the fluidic channel.

15. The apparatus of claim 14, further comprising a prism positioned adjacent to the first planar substrate, and configured to allow light to be coupled into a resonant optical mode confined in the fluidic channel, when the light is incident upon the prism at an angle.

16. The apparatus of claim 15, further comprising means for scanning the light from the excitation light source so that it is incident at the optical waveguide over a range of incident angles, the means for scanning light being selected from a swinging arm or a converging lens or a system of moving mirrors.

17. The apparatus of claim 16, further comprising means for providing light capable of exciting either transverse electric or transverse magnetic modes.

18. The apparatus of claim 17, further comprising means for detecting an angle dependent dip or peak in the intensity of the light coupled from the waveguide.

19. The apparatus of claim 18, further comprising means for detecting single or multiple dips or peaks in intensity of reflected light.

20. A method for optically measuring one or more of fluorescence intensity, optical density and refractive index in a test sample, the method comprising:
a) inserting the test sample or the cuvette containing the test sample into a housing, the housing having a detection region;
b) sensing the temperature of one or more of the housing, the detection region, the test sample or the cuvette;
c) modulating the temperature of one or more of the housing, the detection region, the test sample or the cuvette within a desired range;
d) either directing excitation light through the test sample, and detecting the emission light from the test sample, the one or more detectors being capable of converting the detected emission light into an output signal; or
directing the probe light to the test sample and at one or more detectors; and
e) transmitting the output signal to the control system, the control system being capable of converting the output signal into output data representative of the fluorescence intensity, optical density and/or refractive index of the test sample.
